(19) United States
(12) Patent Application Publication
(10) Pub. No.: US 2015/0070885 A1
(43) Pub. Date: Mar. 12, 2015

(54) U-SHAPED LIGHT EMITTING DIODE TUBE LAMP

(71) Applicants: Alfred Petro, Shenzhen (CN); Gregory Hawkins, Dublin, OH (US)

(72) Inventors: Alfred Petro, Shenzhen (CN); Gregory Hawkins, Dublin, OH (US)

(21) Appl. No.: 14/480,173

(22) Filed: Sep. 8, 2014

Related U.S. Application Data
(60) Provisional application No. 61/874,414, filed on Sep. 6, 2013.

(51) Int. Cl. F21K 99/00; F21V 23/00; F21V 3/04; F21V 23/06

(52) U.S. Cl. CPC F21K 9/175; F21V 23/06; F21V 23/005; F21V 3/04; F21Y 2103/025
USPC 362/223; 29/832; 362/217.13

(57) ABSTRACT

An LED lamp for use in two-by-two light fixtures having coplanar electrical receptacles. The LED lamp is ideal for use as a replacement of fluorescent lamps in existing fluorescent fixtures and is U shaped with electrical connectors at each end. The U shaped elongate tube is made of an outer shell defining a cavity with a PCB mounted therein. The LED elements are mounted on the PCB. The LED lamp does not have coupling connectors enabling it to emit light along the entire axial length of the tube.

### CROSS-REFERENCE TO RELATED APPLICATIONS

This application claims priority to U.S. Provisional Application No. 61/874,414 filed 6 Sep. 2013, the content of which is hereby incorporated by reference as if fully recited herein.

### TECHNICAL FIELD

Exemplary embodiments of the present invention relate generally to light emitting diode (LED) tube lamps, and more particularly to an LED tube lamp configured for installation and use in existing bent tube or two-by-two fluorescent light fixtures.

### BACKGROUND AND SUMMARY OF THE INVENTION

Fluorescent light sources have dominated the market for indoor light sources in commercial, industrial and to some extent residential applications for decades. The commercial competitiveness of indoor LED light sources relative to fluorescent light sources has rapidly increased in recent years due to the development and refinement of the technology. For example, the luminoscity of LED light sources are now comparable to fluorescent light sources, and upfront and maintenance costs have fallen dramatically since the inception of the technology. Furthermore, consumers' ever increasing consciousness of the environmental impact of their consumption choices has led to increased demand for “green”—i.e., environmentally friendly—technology. These technological and cultural developments have resulted in a need for indoor LED light source products.

Fluorescent technology's saturation of the indoor lighting market has meant that the vast majority of spaces with lighting needs are currently configured with fluorescent light fixtures. In order to further increase the commercial competitiveness of LED light source technology, manufacturers have begun to offer LED fluorescent replacement tubes for installation and use in existing fluorescent light fixtures. Typical fluorescent light fixtures are configured to receive one or more fluorescent tube lamps having end caps with electrical connectors, such as electrodes, for connection to a power source. The electrical receptacles into which the fluorescent tubes are placed are also typically housed within a troffer, box, cover, or other such partial or full enclosure that generally defines the space occupied by the light fixture. The fixtures are commonly mounted in ceiling spaces and come in a very large variety of unique configurations.

A particular type of fluorescent light fixture is referred to commonly as a “two-by-two” fixture. Two-by-two fixtures are frequently deployed in situations with tighter space requirements, such as small offices. Although not limited to those uses, two-by-two fixture troffers are relatively shorter in length than other standard fluorescent light fixtures because they are configured to receive a single fluorescent tube lamp bent into a “U” shape. This configuration can also be advantageous for use in cantilevered light fixtures, for example. The two-by-two fixtures are thus configured with coplanar electrode receptacles at one end of the fixture only. When installed, the two-by-two tube lamps (also referred to as bent tube lamps, U-bent tubes, U-shaped bulbs, U-tubes, etc.) begin at an electrical receptacle at one end of the fixture, extend along the its length to its other end, bend 180 degrees and return to a second electrical receptacle at the original end of the fixture.

Currently, LED replacement tube lamps are manufactured by generally inserting a plurality of LEDs mounted on a printed circuit board into a tube terminating at both ends with end caps designed to fit into existing fluorescent receptacles. Two-by-two replacement tube lamps are made with two such lamps that have a coupling conduit connecting one end of each tube. Those conduits can carry electrical connections between the lamps if desired, and are typically formed of a plastic material. Further disclosure of exemplary prior art methods may be found in United States Publication No. US2013/0010459 A1, for instance.

These prior art methods present several disadvantages in the use of U-shaped LED replacement tube lamps. For example, the use of a U-shaped connector decreases the effectiveness of the lamp by decreasing its total light output potential, and by further creating a discrete longitudinal area from which no light is emitted when compared to the fluorescent tube lamps it is meant to replace. Therefore, there exists a current need in the art for an LED fluorescent replacement tube lamp that emits light along its entire, continuous tube length. No known references, taken alone or in combination, are seen as teaching or suggesting the presently claimed apparatus for holding an electronic device at a work surface.

### BRIEF SUMMARY OF THE INVENTION

Exemplary embodiments of the present disclosure pertain to

An object of the present invention

It is an object of this invention to provide a [invention] of the type generally described herein, being adapted for the purposes set forth herein, and overcoming disadvantages found in the prior art. These and other advantages are provided by the invention described and shown in more detail below.

### BRIEF DESCRIPTION OF THE SEVERAL VIEWS OF THE DRAWINGS

Novel features and advantages of the present invention, in addition to those mentioned above, will become apparent to those skilled in the art from a reading of the following detailed description in conjunction with the accompanying drawings wherein identical reference characters refer to identical parts and in which:

FIG. 1 is a perspective view of an exemplary embodiment of the present invention;

FIG. 2 is a perspective view of an exemplary embodiment of the present invention;

FIG. 3 is an anterior view of an exemplary embodiment of the present invention;

FIG. 4 is a sinistral side view of an exemplary embodiment of the present invention;

FIG. 5 is a bottom view of an exemplary embodiment of the present invention;

FIG. 6 is a perspective view of an exemplary embodiment of the elongate tube and connector elements of the present invention;

FIG. 7 is an anterior view of an exemplary embodiment of the elongate tube and connector elements of the present invention;

FIG. 8 is a sinistral view of an exemplary embodiment of the elongate tube and connector elements of the present invention;

FIG. 9 is a bottom view of an exemplary embodiment of the elongate tube and connector elements of the present invention;

FIG. 10 is an anterior view of an exemplary embodiment of the printed circuit board element of the present invention;

FIG. 11 is a perspective view of an exemplary embodiment of the printed circuit board element of the present invention; and

FIG. 12 is a top view of an exemplary embodiment of the printed circuit board element of the present invention.

### DETAILED DESCRIPTION OF THE INVENTION

Exemplary embodiments of the present invention are directed to U shaped LED tube lamps in which light is emitted along the continuous length of the tube. The embodiments generally do not have U shaped connectors known in the prior art for joining two LED tubes, but may be optionally configured with reinforcing support members for strengthening the lamp structure that do not obstruct light emission along an appreciable longitudinal length of the tube, without departing from the teachings herein.

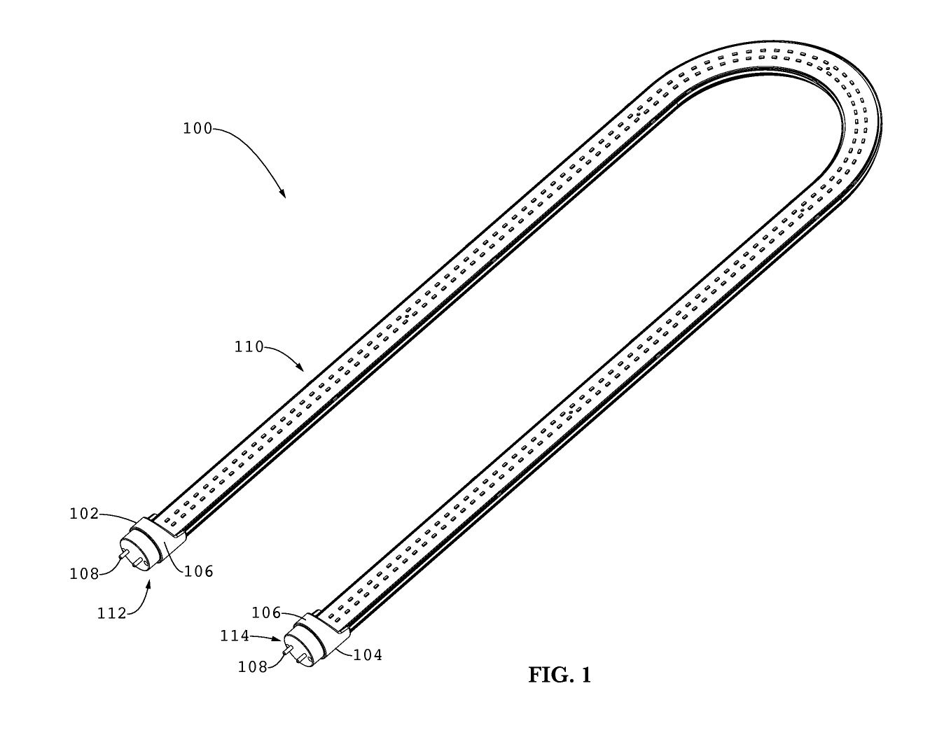

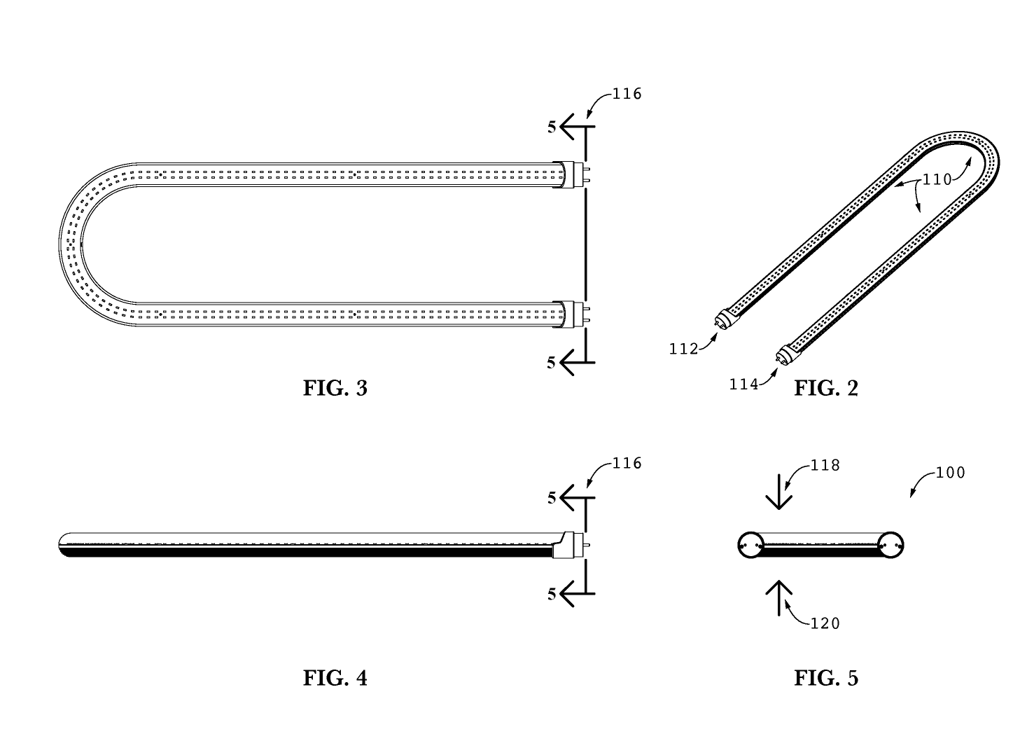

A preferred embodiment of the present invention is shown in perspective view in FIG. 1 as LED U replacement lamp 100. The lamp 100 has first 102 and second 104 connectors generally configured for insertion into and electrically coupling with an electrical receptacle in a fluorescent light fixture (not shown). For example, the embodiment shown in FIG. 1 depicts the use end caps 106 that fit around the tube 110 circumference and extend electrodes 108 through the caps 106 for insertion into fixture receptacles. Note that, while this configuration is preferred, a connector may be of any type that generally seals the lamp 100 interior elements and surfaces from the surrounding environment and provides an electrical connection to a fixture. The present invention is not limited to use in existing fluorescent fixtures, but may be employed in new fixtures designed specifically for LED lamps without departing from the teachings herein. Furthermore, various connector configurations are known in the art; and other such configurations may be used, such as plug configurations fitting within the tube 110 circumference, threaded configurations, or the like.

First connector 102 is coupled to a first end 112 of the elongate tube 110, which extends lengthwise to a second end 114, terminating at a second connector 104 coupled thereto. The elongate tube 110 element is generally U shaped such that its first 112 and second 114 tube ends and first 102 and second 104 connectors coupled thereto, respectively, are coplanar in plane 5-5 (FIGS. 3 and 4) at the bottom of the lamp 100. FIG. 5 is viewed from the direction of arrow 116 at plane 5-5 in FIG. 4. In FIG. 5, the front or anterior side of the lamp 100 is indicated by arrow 118, and the back or posterior side of the lamp 100 is indicated by arrow 120. For reference purposes only, the anterior side of the lamp 100 depicted in the embodiments described herein will be referenced as the side of the lamp 100 that generally faces the space to be lighted (i.e., away from the fixture and toward an interior room). However, it is should be readily apparent that the orientation and characteristics of the particular fixture involved in an application will necessarily dictate the final orientation of the invented lamp 100.

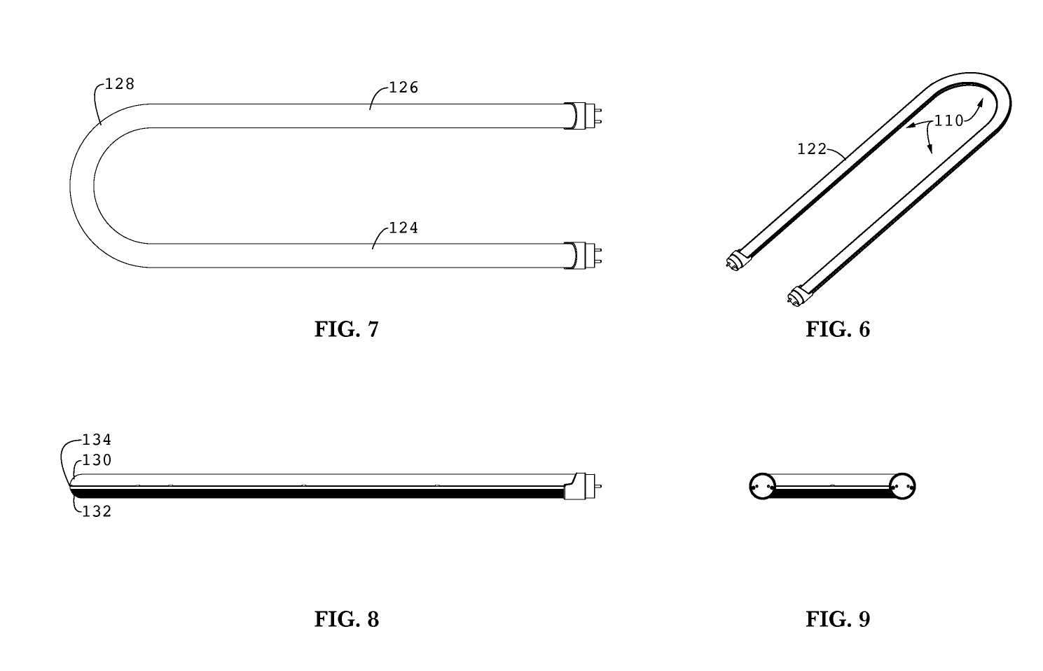

The elongate tube 110 is made of an outer shell 122, a portion or all of which being light permeable. The outer shell 122 of tube 110 is shown in FIG. 6. The exterior surface of the shell 122 defines the outer bounds of the tube, while its interior surface defines a tube cavity in which the LED elements and electronic circuitry are housed. The outer shell 122 cross section is circular in the preferred embodiment, but may be configured to be generally any shape having a perimeter, preferably a regular convex shape. Preferably, the shape and characteristics of the tube 110 and shell 122 of a product manufactured in accordance with this disclosure conform to industry standards as outlined in ANSI (American National Standards Institute) C78.901-2005 with regards to length, cross sectional shape and diameter, and other such characteristics. However, this disclosure applies to all permutations of such configurable variables as they apply to other non-standard applications.

The present invention utilizes U shaped elongate tubes such as 110 shown as an exemplary embodiment. The outer shell 122 defines an elongate tube axis (not shown) that represents the lengthwise U shaped path formed by the elongate tube 110 between the connectors 102 and 104. Any general U shape defined by the tube axis in which the ends 112 and 114 of the tube 110 (and axis) are coterminous in a common plane, thereby enabling the lamp 100 to be installed into coplanar fixture receptacles is considered applicable to the disclosure contained herein.

As an example, the preferred embodiment of the elongate tube 110 (and its corresponding axis) shown in FIGS. 6-9 has three distinct sections: a linear sinistral section 124, a linear dextral section 126, and a curved middle section 128. It is preferred that the middle section 128 is semicircular within a definable curvature radius—common in the fluorescent lamp industry—but may be curved generally so that it connects the linear sinistral section 124 with the linear dextral section 126.

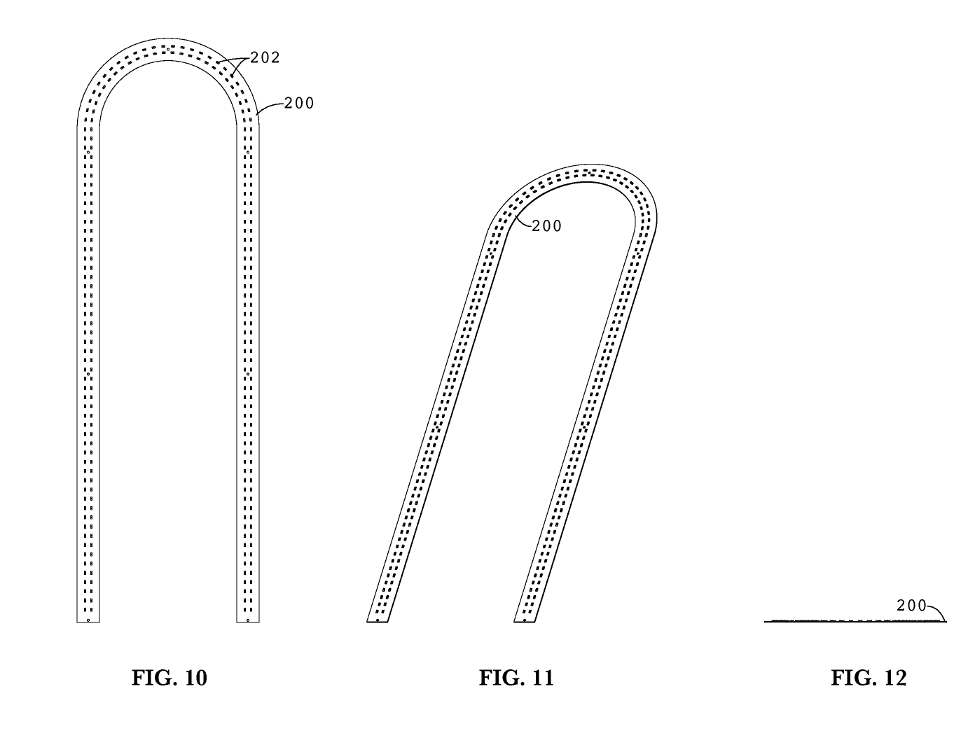

FIGS. 10-12 depict an exemplary form of the PCB element 200 of the present invention that is housed within and shaped to fit the tube 110 cavity. FIG. 10 shows an anterior view of the PCB 200. LED elements 202 are mounted on at least one side of the PCB 200. The tube 110 is preferably formed of two partial outer shell 122 sections, an anterior section 130 and a posterior section 132, for example, by mounting the printed circuit board (PCB) 200 within one of the sections 130, 132 and sealing the sections together at a seam 134. It is preferred that the tube 110 by formed of two partial outer shell sections 130, 132, with the PCB 200 fastened to the posterior section 132. The PCB 200 is preferably mounted and fastened to the posterior section 132 using screws or other such fasteners, for example. It is considered the best mode of manufacture to seal the sections 130, 132 together by ultrasonically welding them together at the seam 134. It is further preferred that, in applications complying with ANSI standards, for the connectors 102, 104 to be screwed onto the tube ends 112, 114, with one G13 (medium bi-pin) connector (e.g., 102) being positive and the remaining connector being negative (e.g., 104). These preferred methods result in standards compliant, sealed lamps 100 devoid of unsightly fasteners visible externally from the lamp.

Alternative to the seam being oriented to be generally coplanar with the PCB, three or more sections of outer shell may optionally be coupled to form the tube at seams along the axial length of the tube. Forming a tube comprised of two or more outer shell sections allows for a single continuous rigid PCB to be manufactured and used in the lamp, eliminating the possibility for electrical connection failures between contiguous PCB sections, and to ensure secure mounting within the tube. The PCB may also optionally be a flexible-type PCB that can be drawn through the tube for installation and mounting therein. The design of such a PCB may be readily accomplished by one skilled in the art. The elongate tube may also be formed of a single continuous outer shell by bending, extrusion, or other comparable methods.

All of the disclosed methods for constructing the elongate tube element 110 allow the lamp to emit light along the entire length of its tube, thereby emitting more light than prior art lamps while also eliminating any “dead” or unlighted portions along the axial length of the tube. The invented lamp does not have any coupling conduit as a result.

The outer shell 122 may optionally be comprised entirely of light permeable material, including but not limited to, for example, clear or frosted material. Alternatively, it could be comprised of a section of light permeable and a section of opaque, reflective or a combination of both types of material. The PCB 200 may be similarly configured with LED elements 202 mounted on one side of the PCB 200, or both sides. The preceding design choices will vary according to application, and each may be made independently of the other. The optional mounting of LED elements 202 on both sides of the PCB 200 allow the lamp 100 to use reflection in combination with the outer shell 122 to increase the luminosity of light in a particular direction as will be apparent to those skilled in the art. Fully light permeable outer shell configurations may also, for instance, take advantage of light fixture characteristics to make use of LED elements deployed on both sides of the PCB.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. An LED tube lamp for use in bent tube fixtures comprising:
an elongate tube comprising:
an axial length;
a first tube end;
a second tube end; and
an outer shell defining a cavity and an elongate tube axis,
wherein the elongate tube axis traverses the longitudinal length of the elongate tube and is U-shaped;
a printed circuit board housed within the cavity and having an anterior surface and a posterior surface;
a plurality of LEDs mounted on the anterior surface of the printed circuit board;
a first connector coupled to the first tube end; and
a second connector coupled to the second tube end.

2. The LED tube lamp of claim 1, the elongate tube axis further comprising:
a linear sinistral section;
a linear dextral section; and
a curved middle section,
wherein the middle section links the linear sinistral section and the linear dextral section so that the elongate tube axis is U-shaped.

3. The LED tube lamp of claim 1, the elongate tube axis further comprising:
a linear sinistral section;
a linear dextral section; and
a semi-circular middle section,
wherein the semi-circular middle section has a radius of curvature and links the linear sinistral section and the linear dextral section so that the elongate tube axis is U-shaped.

4. The LED tube lamp of claim 2, wherein the printed circuit board is unitary and continuous and formed of a rigid material.

5. The LED tube lamp of claim 2, wherein the printed circuit board is unitary and continuous and formed of a flexible material.

6. The LED tube lamp of claim 3, wherein the printed circuit board is unitary and continuous and formed of a rigid material.

7. The LED tube lamp of claim 3, wherein the printed circuit board is unitary and continuous and formed of a flexible material.

8. The LED tube lamp of claim 6, wherein the outer shell is light permeable.

9. The LED tube lamp of claim 8, further comprising a plurality of LEDs mounted on the posterior surface of the printed circuit board.

10. The LED tube lamp of claim 1, wherein the outer shell further comprises:
a light permeable anterior outer shell section; and
a posterior outer shell section,
wherein the anterior and posterior outer shell sections are coupled to define the cavity.

11. The LED tube lamp of claim 1, wherein the outer shell further comprises:
a light permeable anterior outer shell section; and
a posterior outer shell section,
wherein the printed circuit board is fastened to the posterior outer shell section.

12. The LED tube lamp of claim 11, wherein the anterior and posterior outer shell sections are coupled to define the cavity.

13. The LED tube lamp of claim 11, wherein the anterior and posterior outer shell sections are ultrasonically welded at a seam and together define the cavity.

14. The LED tube lamp of claim 10, further comprising a plurality of LEDs mounted on the posterior surface of the printed circuit board, and wherein the posterior outer shell section comprises a light-reflective cavity-facing surface reflecting light emitted from the LEDs mounted on the posterior surface.

15. The LED tube lamp of claim 10, wherein the posterior outer shell section comprises an opaque surface.

16. An LED tube lamp formed by a process comprising the steps of:
forming a light permeable anterior outer shell section in a U shape;
forming a posterior outer shell section in a U shape;
mounting a plurality of light emitting diodes on an anterior surface of a U shaped printed circuit board;
fastening the printed circuit board to the posterior outer shell section;
ultrasonically welding the anterior outer shell section to the posterior outer shell section to form an elongate tube with a first tube end and a second tube end;
screwing a first connector onto the first tube end; and
screwing a second connector onto the second tube end.

17. An LED tube lamp formed by a process comprising the steps of:
forming an elongate tube from a light permeable outer shell defining a cavity into a U shape, wherein the elongate tube has a first tube end and a second tube end;
drawing a flexible printed circuit board with a plurality of light emitting diodes mounted thereon through the cavity;
affixing the printed circuit board within the cavity;
coupling a first connector to the first tube end; and
coupling a second connector to the second tube end.
